(19) United States
(12) Patent Application Publication
(10) Pub. No.: US 2024/0073825 A1
(43) Pub. Date: Feb. 29, 2024

(54) METHOD OF REPEATEDLY TRANSMITTING UPLINK SIGNALS IN WIRELESS COMMUNICATION SYSTEM AND ELECTRONIC DEVICE THEREF

(71) Applicant: Samsung Electronics Co., Ltd., Suwon-si (KR)

(72) Inventors: Byongok Lee, Suwon-si (KR); Joohyun Do, Suwon-si (KR); Hyunseok Yu, Suwon-si (KR)

(73) Assignee: Samsung Electronics Co., Ltd., Suwon-si (KR)

(21) Appl. No.: 18/239,269

(22) Filed: Aug. 29, 2023

(30) Foreign Application Priority Data
Aug. 29, 2022 (KR) 10-2022-0108727

(51) Int. Cl. H04W 52/14; H04W 52/18; H04W 52/42

(52) U.S. Cl. CPC H04W 52/146; H04W 52/18; H04W 52/42

(57) ABSTRACT

Provided is a method of operating an electronic device, the method including receiving, from a base station, a downlink control signal requesting repeated transmission of an uplink signal, determining a repeated transmission mode for changing at least one of a precoding matrix, an analog transmission beam, and transmission power of the uplink signal when the uplink signal is repeatedly transmitted in response to reception of the downlink control signal, and repeatedly transmitting a plurality of uplink signals according to a determined repeated transmission mode.

### CROSS-REFERENCE TO RELATED APPLICATION

This application is based on and claims priority to Korean Patent Application No. 10-2022-0108727, filed on Aug. 29, 2022, in the Korean Intellectual Property Office, the disclosure of which is incorporated by reference herein in its entirety.

### BACKGROUND

The embodiments of the disclosure relate to a method of transmitting uplink signals and an electronic device therefor, and more particularly, to a method of repeatedly transmitting an uplink signal in a wireless communication system and an electronic device therefor.

Efforts are being made to develop an improved 5th generation (5G) communication system or a pre-5G communication system in order to meet the increasing demand for wireless data traffic after commercialization of the 4th generation (4G) communication system. For this reason, the 5G communication system or the pre-5G communication system is referred to as a New Radio (NR) system in the 3GPP standard.

In order to achieve high data rates, 5G communication systems use a very high frequency (mmWave) band (e.g., a 28 GHz band, a 39 GHz band, etc.). In order to reduce the path loss of radio waves and increase the propagation distance of the radio waves in the ultra-high frequency band for the 5G communication system, techniques like beam-forming, massive Multiple Input Multiple Output (MIMO), and Full Dimensional MIMO (FD-MIMO), array antenna, analog beam-forming, hybrid beam-forming, and large scale antenna are being discussed.

### SUMMARY

The embodiments of a disclosure provide an electronic device and a method of operating the same for changing at least one of a precoding matrix, transmission power, and an analog transmission beam when an uplink signal is repeatedly transmitted according to a New Radio (NR) Physical Uplink Shared CHannel (PUSCH) repetition mode.

According to embodiments, there is provided a method of operating an electronic device, the method including: receiving, from a base station, a downlink control signal requesting repeated transmission of an uplink signal; determining a repeated transmission mode for changing at least one of a precoding matrix, an analog transmission beam, and transmission power of the uplink signal when the uplink signal is repeatedly transmitted in response to reception of the downlink control signal; and repeatedly transmitting the uplink signal according to a determined repeated transmission mode.

According to embodiments, there is provided an electronic device including: a communication circuit configured to receive, from a base station, a downlink control signal requesting repeated transmission of an uplink signal; and a processor configured to: determine a repeated transmission mode for changing one of a precoding matrix, an analog transmission beam, and transmission power of the uplink signal; and repeatedly transmit the uplink signal according to the determined repeated transmission mode.

According to embodiments, there is provided an electronic device including: a communication circuit configured to receive, from a base station, a downlink signal requesting repeated transmission of an uplink signal; and a processor configured to change at least one of a precoding matrix, an analog transmission beam, and transmission power of the uplink signal when the uplink signal is repeatedly transmitted to the base station.

### BRIEF DESCRIPTION OF DRAWINGS

Embodiments of the disclosure will be more clearly understood from the following detailed description taken in conjunction with the accompanying drawings, in which:

FIG. 1 is a diagram showing a wireless communication system, according to an embodiment;

FIG. 2 is a block diagram of an electronic device, according to embodiments;

FIG. 3 is a detailed block diagram of a processor, according to embodiments;

FIG. 4 is a detailed block diagram of a communication circuit, according to embodiments;

FIG. 5 is a diagram showing signal exchange between a base station and an electronic device, according to embodiments;

FIG. 6 is a flowchart of a method of operating an electronic device, according to embodiments;

FIGS. 7A to 7C are flowcharts showing operation sequences of determining a repeated transmission mode, according to embodiments;

FIGS. 8A to 8C are flowcharts showing other operation sequences of determining a repeated transmission mode, according to embodiments;

FIG. 9 is a flowchart showing still another operation sequence of an embodiment for determining a repeated transmission mode, according to embodiments;

FIG. 10 shows a result graph, according to embodiments; and

FIG. 11 is a block diagram of a wireless communication device according to an embodiment.

### DETAILED DESCRIPTION OF EMBODIMENTS

The embodiments described herein are example embodiments, and thus, the disclosure is not limited thereto and may be realized in various other forms. Each of the embodiments provided in the above description is not excluded from being associated with one or more features of another example or another embodiment also provided herein or not provided herein but consistent with the disclosure. As used herein, an expression “at least one of” preceding a list of elements modifies the entire list of the elements and does not modify the individual elements of the list. For example, an expression, “at least one of a, b, and c” should be understood as including only a, only b, only c, both a and b, both a and c, both b and c, or all of a, b, and c.

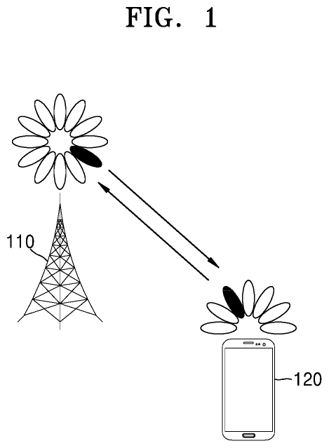

FIG. 1 is a diagram showing a wireless communication system, according to an embodiment.

Referring to FIG. 1, a wireless communication system may include a base station 110, an electronic device 120.

According to various embodiments, the base station 110 is a network infrastructure that provides a wireless connection to the electronic device 120. The base station 110 may have coverage defined as a certain geographic area based on a distance to which signals may be transmitted. The base station 110 may also be referred to as an ‘access point (AP)’, an ‘eNodeB (eNB)’, a ‘5th generation (5G) node’, a ‘gNodeB (gNB)’, a ‘wireless point’, or any of other terms having equivalent technical meanings.

The base station 110 may transmit a downlink control signal to the electronic device 120. The base station 110 may receive an uplink signal from the electronic device 120, but may fail to receive uplink data due to deterioration of an uplink channel. The base station 110 may transmit the downlink control signal to the electronic device 120 for reliable communication. The downlink control signal may include, for example, a signal for instructing a New Radio (NR) Physical Uplink Shared CHannel (PUSCH) repetition mode to the electronic device 120. The downlink control signal instructing the NR PUSCH repetition mode may include information regarding the number of times that the electronic device 120 needs or is required to repeatedly transmit an uplink signal to the base station 110.

According to various embodiments, the electronic device 120 is a device used by a user, and may communicate with the base station 110 through a wireless channel. The electronic device 120 may also be referred to as a ‘user equipment (UE)’, a ‘mobile station’, a ‘subscriber station’, ‘customer premises equipment (CPE)’, a ‘remote terminal’, a ‘wireless terminal’, a ‘user device’, or any of other terms having equivalent technical meanings.

The electronic device 120 may receive a downlink control signal from the base station 110. The downlink control signal may include a signal instructing the electronic device 120 to repeatedly transmit an uplink signal to the base station 110. For example, the downlink control signal may be a PUSCH repetition configuration signal or a PUSCH repetition grant signal which may instruct the electronic device 120 to be set to the NR PUSCH repetition mode. The electronic device 120 may transmit an uplink signal including the same data to the base station 110 a plurality of number of times in response to reception of the downlink control signal. According to an embodiment, the repeatedly transmitted same data may be user data (or a payload) such as video, audio, text, etc. transmitted through the PUSCH.

It is understood herein that a k-th uplink signal refers to an uplink signal which is transmitted subsequent to or right after the uplink signal is transmitted k−1 times during repeated transmission of the uplink signal. The k may be any natural number from 1 to 8, for example, not being limited thereto. Thus, a first uplink signal refers to an initially transmitted uplink signal during the repeated transmission of the uplink signal, a second uplink signal refers to an uplink signal transmitted subsequent to the initial uplink signal or right after the uplink signal is initially transmitted, and a third uplink signal refers to an uplink signal transmitted subsequent to the second uplink signal or right after the second uplink signal is transmitted.

According to embodiments, the electronic device 120 may repeatedly transmit an uplink signal a plurality of times, and may change at least one of a precoding matrix, an analog transmission beam, and a transmission power value when the uplink signal is repeatedly transmitted. For example, the electronic device 120 may transmit an uplink signal to the base station 110 twice. A first uplink signal transmitted during the repeated transmission may be transmitted through a first analog transmission beam from among a plurality of analog transmission beams directed toward the base station 110. A second uplink signal transmitted during the repeated transmission may be transmitted through a second analog transmission beam from among the plurality of transmission beams directed toward the base station 110. The first analog transmission beam may be a different beam from the second analog transmission beam, for example, in at least one of a direction, an amplitude or magnitude, a phase, a frequency, and polarization, although the two uplink signal include the same data. According to an embodiment, the first uplink signal transmitted during the repeated transmission may be transmitted based on a first precoding matrix. The second uplink signal transmitted during the repeated transmission may be transmitted based on a second precoding matrix. The first precoding matrix may be different from the second precoding matrix, for example, in at least one weight affecting at least one of an amplitude or magnitude and a phase. According to an embodiment, the first uplink signal transmitted during the repeated transmission may be amplified according to a first transmission power value and transmitted. The second uplink signal transmitted during the repeated transmission may be amplified according to a second transmission power value and transmitted. The first transmission power value may be different from the second transmission power value. Detailed descriptions of changing at least one of the precoding matrix, the analog transmission beam, and the transmission power value when an uplink signal is repeatedly transmitted will be described later. According to an embodiment, in response to the downlink control signal instructing the NR PUSCH repetition mode, the electronic device 120 repeatedly transmit the uplink signal every time the uplink signal is transmitted for the predetermined number of times, e.g., k times.

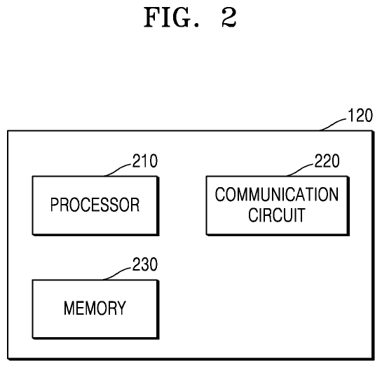

FIG. 2 is a block diagram of an electronic device, according to embodiments.

Referring to FIG. 2, the electronic device 120 may include at least one processor 210, a communication circuit 220, and a memory 230.

The processor 210 may control all operations of the electronic device 120. For example, the processor 210 may transmit and receive or control transmission and reception of signals, including uplink signals, through the communication circuit 220. Also, the processor 210 may write data to and read data from the memory 230. To this end, the processor 210 may be at least one microprocessor with a central processing unit (CPU) including related software and/or firmware for controlling the transmission and reception of signals through the communication circuit 220 as well as controlling other functions of the electronic device 120. When the processor 210 is a part of another processor, a part of the communication circuit 220 and the processor 210 may be collectively referred to as a communication processor (CP). The communication circuit 220 may include at least one of a digital modem, a radio frequency (RF) modem, an antenna circuit, a WiFi chip, and related software and/or firmware.

According to an embodiment, the processor 210 may determine a repeated transmission mode. The repeated transmission mode may be a mode for repeatedly transmitting an uplink signal to the base station 110 in response to a downlink control signal received from the base station 110. The downlink control signal may include a signal instructing an NR PUSCH repetition mode. For example, the NR PUSCH repetition mode may be a mode requesting to repeatedly transmit an uplink signal k times as described above. The processor 210 may determine the repeated transmission mode such that an uplink signal is transmitted using a different technique when it is repeatedly transmitted k times. The processor 210 may be configured to change at least one of a precoding matrix, an analog transmission beam, and transmission power when the uplink signal is repeatedly transmitted. In the case of a precoding matrix, the processor 210 may randomly select one precoding matrix from among a plurality of precoding matrices included in a codebook or may select a precoding matrix that is optimal for a result of channel estimation. When a precoding matrix is selected based on a result of channel estimation, a rank of an uplink signal to be transmitted may be maintained at a rank value at the time of initial transmission of the uplink signal. In the case of an analog transmission beam, the processor 210 may randomly select one transmission analog beam from among a plurality of analog transmission beams or select one analog transmission beam estimated as the best analog transmission beam based on a result of channel estimation and use a selected analog transmission beam as an analog transmission beam used for transmitting the uplink signal. When an analog transmission beam is selected based on a result of channel estimation, the rank of an uplink signal to be transmitted may be maintained at a rank value at the time of initial transmission of the uplink signal. The rank of an uplink signal refers to the number of independent signal streams or data streams that can be transmitted simultaneously from the electronic device 120 to the base station 110 over a given channel.

According to an embodiment, when the processor 210 repeatedly transmits an uplink signal k times, the processor 210 may change only one of a precoding matrix, an analog transmission beam, and transmission power at each time of transmitting the uplink signal. For example, the processor 210 may transmit the k uplink signals by selecting different precoding matrices, respectively. As another example, the processor 210 may transmit the k uplink signals by selecting different analog transmission beams, respectively. Yet as another example, the processor 210 may transmit the k uplink signals by setting different transmission power values, respectively.

According to an embodiment, when the processor 210 repeatedly transmits the uplink signal k times, the processor 210 may change two of a precoding matrix, an analog transmission beam, and transmission power at each time of transmitting the uplink signal. For example, the processor 210 may transmit the k uplink signals by selecting different precoding matrices and different analog transmission beams, respectively. As another example, the processor 210 may transmit the k uplink signals by selecting different precoding matrices and different transmission power values, respectively. Yet as another example, the processor 210 may transmit the k uplink signals by setting different analog transmission beams and different transmission power values, respectively.

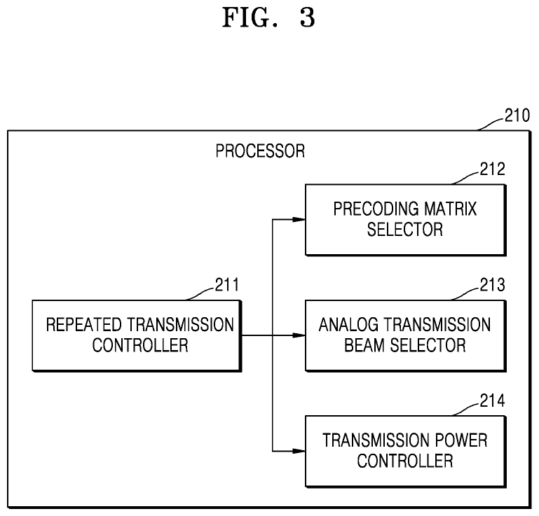

According to an embodiment, when the processor 210 repeatedly transmits the uplink signal, the processor 210 may change all of a precoding matrix, an analog transmission beam, and transmission power. For example, the processor 210 may transmit the k uplink signals by selecting different precoding matrices, different analog transmission beams, and different transmission power values, respectively. Detailed descriptions of the processor 210 will be given below with reference to FIG. 3.

FIG. 3 is a detailed block diagram of the processor 210, according to embodiments.

Referring to FIG. 3, the processor 210 may further include a repeated transmission controller 211, a precoding matrix selector 212, an analog transmission beam selector 213, and a transmission power controller 214, at least one of which may include a direct circuit structure, or may be a software module, firmware, or a combination of hardware and software implemented by a microprocessor including a CPU, according to an embodiment.

The repeated transmission controller 211 may receive a k value obtained by decoding a downlink control signal, which instructs the NR PUSCH repetition mode to the electronic device 120, received from the base station 110. The repeated transmission controller 211 may determine or select a main mode of the repeated transmission modes among a plurality of main modes, and generates and transmits internal control signals to at least one of the precoding matrix selector 212, the analog transmission beam selector 213, and the transmission power controller 214 so that the at least one of the precoding matrix selector 212, the analog transmission beam selector 213, and the transmission power controller 214 may perform corresponding functions, to be described below, according to the determined main mode. The main mode may change one or more of a precoding matrix, an analog transmission beam, and transmission power when an uplink signal is repeatedly transmitted k times. For example, when only one of a precoding matrix, an analog transmission beam, and transmission power is selected (i.e., a first main mode), the repeated transmission controller 211 may determine the repeated transmission mode to change only one of a precoding matrix, an analog transmission beam, and a transmission power value when an uplink signal is repeatedly transmitted. When only two of a precoding matrix, an analog transmission beam, and transmission power are selected (i.e., a second main mode), the repeated transmission controller 211 may determine the repeated transmission mode to change only the precoding matrix and the analog transmission beam, only the analog transmission beam and the transmission power value, or only the precoding matrix and the transmission power value when an uplink signal is repeatedly transmitted. When all of the precoding matrix, the analog transmission beam, and the transmission power vale are selected (i.e., a third main mode), the repeated transmission controller 211 may determine the repeated transmission mode to change all of the precoding matrix, the analog transmission beam, and the transmission power value when an uplink signal is repeatedly transmitted.

When it is determined which one of a precoding matrix, an analog transmission beam, and transmission power is to be changed (the main mode is determined), the repeated transmission controller 211 may determine a sub-mode. The sub-mode may refer to a criterion regarding how to differently select a precoding matrix or an analog transmission beam when the uplink signal is repeatedly transmitted k times.

After it is determined to change a precoding matrix when the uplink signal is transmitted, the repeated transmission controller 211 may determine a sub-mode for the precoding matrix from among a plurality of sub-modes. The sub-modes for the precoding matrix may include a first sub-mode for randomly selecting a precoding matrix and a second sub-mode for selecting a precoding matrix by using a result of channel estimation. The repeated transmission controller 211 may select the first sub-mode, and control the precoding matrix selector 212 to randomly select any one of precoding matrices stored in a codebook when the uplink signal is repeatedly transmitted. The repeated transmission controller 211 may select the second sub-mode, control the precoding matrix selector 212 to select a precoding matrix which is optimal based on a result of channel estimation, and repeatedly transmit the uplink signal based on the selected precoding matrix through the communication circuit 220. However, the second sub-mode may be limited to a case where there is a downlink signal newly received while the uplink signal is being repeatedly transmitted. For example, the electronic device 120 may receive a downlink signal after an uplink signal is transmitted three times. In this case, channel estimation may be performed by using the downlink signal, and then, the repeated uplink signal (e.g., fourth to k-th uplink signals) may be transmitted according to an optimal precoding matrix selected based on a result of the channel estimation.

When it is determined to change an analog transmission beam when the uplink signal is repeatedly transmitted, the repeated transmission controller 211 may determine a sub-mode for the analog transmission beam from among the plurality of sub-modes. The sub-modes for the analog transmission beam may include a third sub-mode for randomly selecting an analog transmission beam and a fourth sub-mode for selecting an analog transmission beam by using a result of channel estimation. The repeated transmission controller 211 may select the third sub-mode, and control the analog transmission beam selector 213 to randomly select any one analog transmission beam from among a plurality of analog transmission beams when the uplink signal is repeatedly transmitted. The repeated transmission controller 211 may select the fourth sub-mode, control the analog transmission beam selector 213 to select an analog transmission beam which is optimal based on a result of channel estimation, and repeatedly transmit the uplink signal through the communication circuit 220 based on the selected analog transmission beam. However, the fourth sub-mode may be limited to a case where there is a downlink signal newly received while the uplink signal is being repeatedly transmitted. For example, the electronic device 120 may receive a downlink signal after a third uplink signal is transmitted, that is after an uplink signal is transmitted three times. In this case, channel estimation may be performed by using the downlink signal, and then, the repeated uplink signal may be transmitted through an optimal analog transmission beam selected based on a result of the channel estimation.

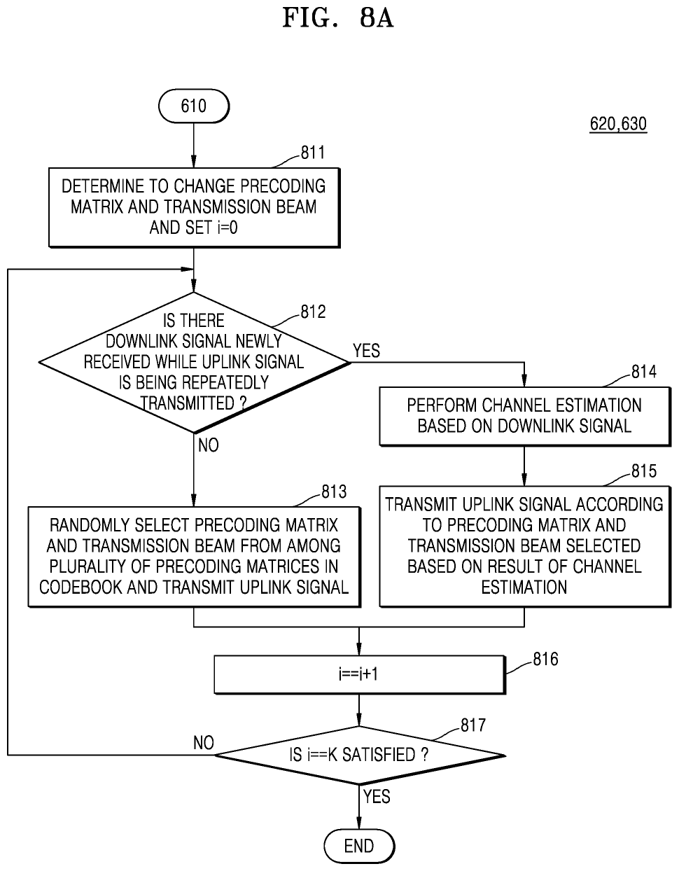

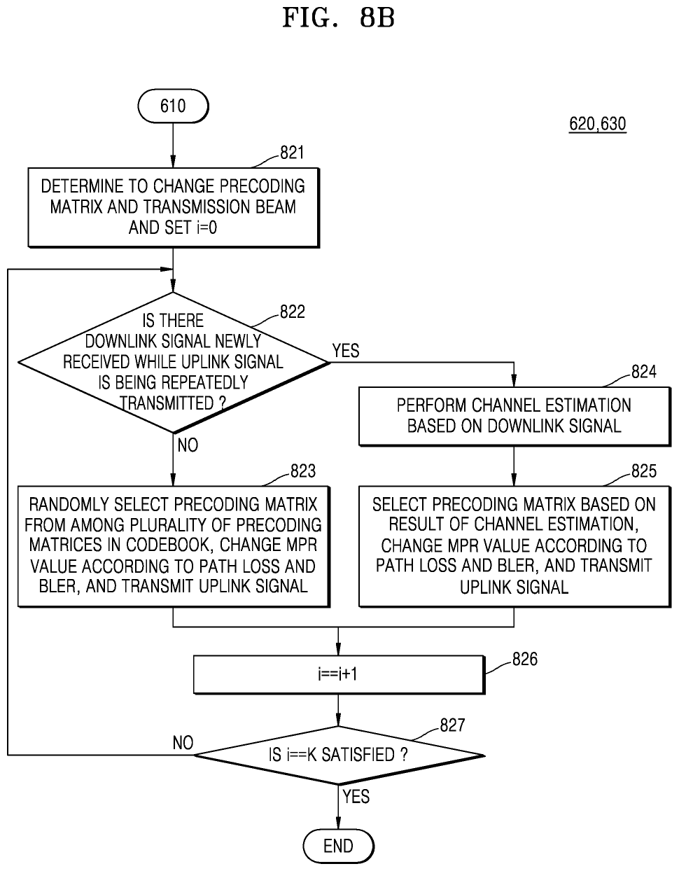

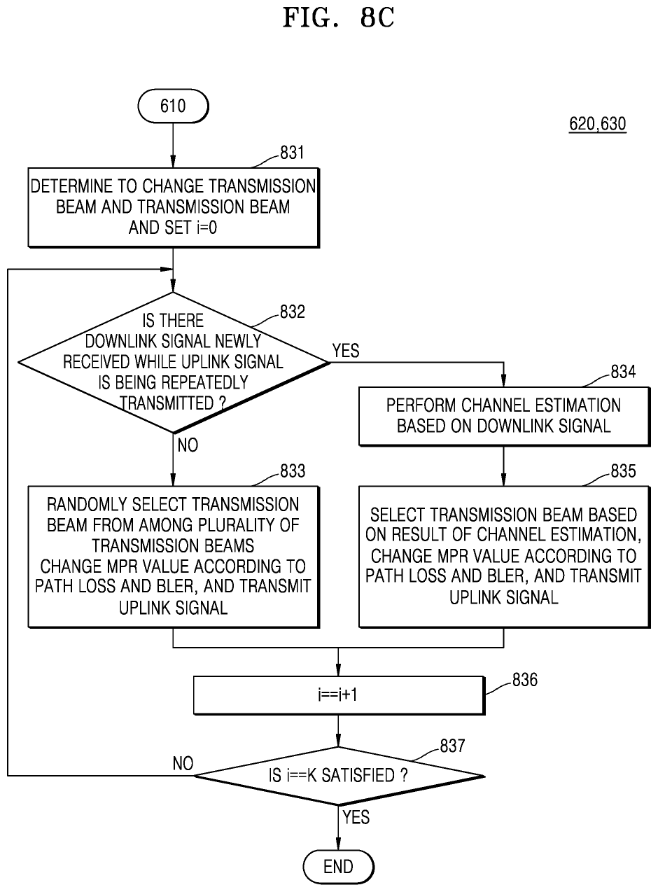

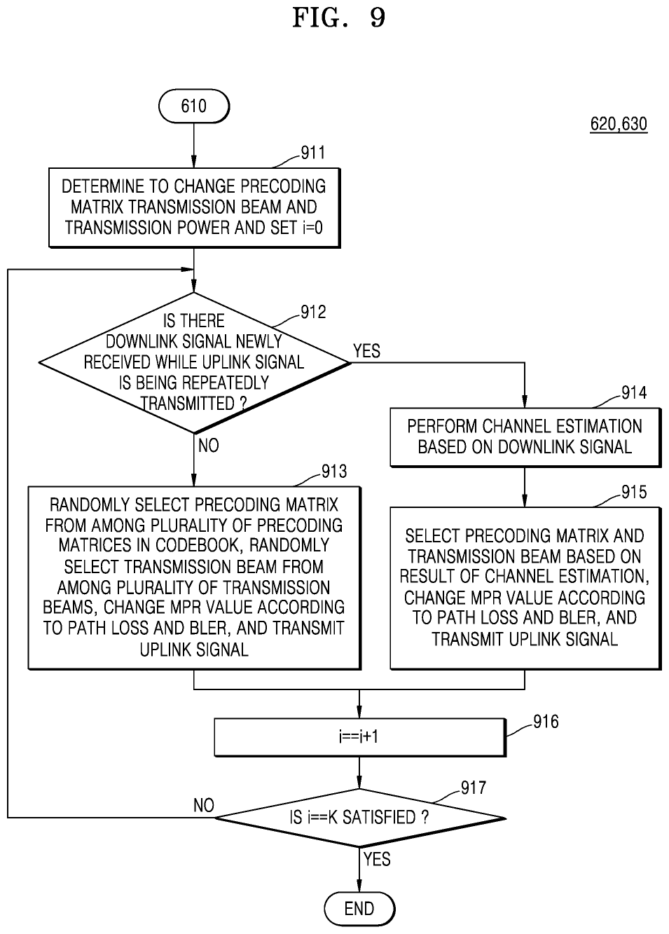

After it is determined to change transmission power when the uplink signal is repeatedly transmitted, the repeated transmission controller 211 may control the transmission power controller 214 to variably set a power reduction value, which may be, for example, a maximum power reduction (MPR) value. The MPR value may indicate a value by which the electronic device 120 may lower the transmission power when an uplink signal is transmitted. In other words, the electronic device 120 may transmit an uplink signal with a transmission power value obtained by subtracting the MPR value from a predetermined transmission power value, which may be, for example, a maximum transmission power value of the electronic device 120. The repeated transmission controller 211 may monitor a path loss value and a block error rate (BLER) value. The repeated transmission controller 211 may variably set the MPR value to be inversely proportional to the path loss value and the BLER value. For example, as increases in the path loss value and the BLER value indicate deterioration of a channel condition, the repeated transmission controller 211 may be controlled to reduce the MPR value for repeated transmission of the uplink signal with a transmission power value approximate to the maximum transmission power value. As another example, since decreases in the path loss value and the BLER value indicate improvement of a channel condition, the repeated transmission controller 211 may be controlled to increase the MPR value for repeated transmission of the uplink signal with lower transmission power. An embodiment in which the repeated transmission controller 211 determines the main mode of the repeated transmission mode as the second main mode or the third main mode will be described later with reference to FIGS. 8A to 8C and 9.

The precoding matrix selector 212 may select a precoding matrix for transmitting an uplink signal based on a sub-mode. The repeated transmission controller 211 may provide a control signal instructing a sub-mode for a precoding matrix to the precoding matrix selector 212. For example, the control signal may be a 1-bit signal. When the control signal is “logic high”, the sub-mode may be the first sub-mode. In the first sub-mode, the precoding matrix selector 212 may randomly select one precoding matrix from among a plurality of precoding matrices in a codebook. Although not shown, the precoding matrix selector 212 may further include a random number generator for randomly selecting a precoding matrix. When the control signal is “logic low”, the sub-mode may be the second sub-mode. In the second sub-mode, the precoding matrix selector 212 may receive a result of channel estimation from a channel estimator (not shown) and select an optimal precoding matrix.

The analog transmission beam selector 213 may select an analog transmission beam for the repeated transmission controller 211 to transmit an uplink signal through the communication circuit 220 based on a sub-mode. The repeated transmission controller 211 may provide a control signal instructing a sub-mode for an analog transmission beam to the analog transmission beam selector 213. For example, the control signal may be a 1-bit signal. When the control signal is “logic high”, the sub-mode may be the third sub-mode. In the third sub-mode, the analog transmission beam selector 213 may randomly select an analog transmission beam from among a plurality of analog transmission beams. Although not shown, the analog transmission beam selector 213 may further include a random number generator for randomly selecting an analog transmission beam. When the control signal is “logic low”, the sub-mode may be the fourth sub-mode. In the fourth sub-mode, the analog transmission beam selector 213 may receive a result of channel estimation from the channel estimator (not shown) and select an analog transmission beam.

The transmission power controller 214 may select a transmission power value for an uplink signal by variably setting the MPR value. The repeated transmission controller 211 may provide a control signal instructing a sub-mode for changing the MPR value to the transmission power controller 214. The control signal may be a 1-bit signal. When the control signal is “logic high”, the transmission power controller 214 may increase the MPR value by a first predefined value. When the control signal is “logic low”, the transmission power controller 214 may decrease the MPR value by a second predefined value which may be equal to or different from the first predefined value. In other words, when the path loss value and the BLER value increase, the repeated transmission controller 211 may provide a “logic low” control signal to the transmission power controller 214 to lower the MPR value and increase the transmission power for an uplink signal, thereby decreasing the probability of transmission failure of the base station 110. When the path loss value and the BLER value decrease, the repeated transmission controller 211 may provide a “logic high” control signal to the transmission power controller 214 to increase the MPR value and decrease the transmission power for an uplink signal, thereby reducing power consumption of the electronic device 120.

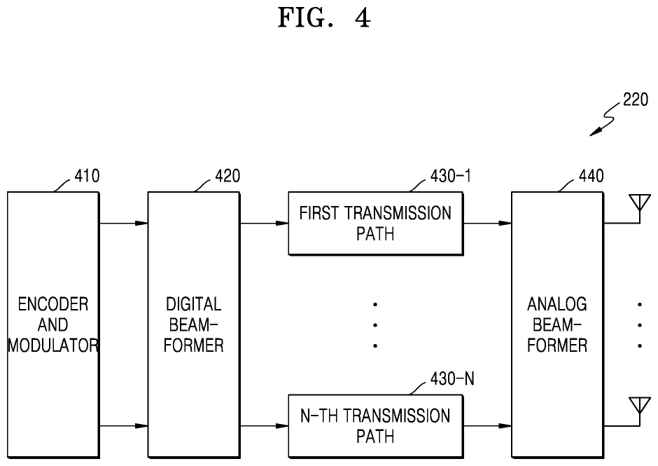

FIG. 4 is a detailed block diagram of the communication circuit 220, according to embodiments.

Referring to FIG. 4, the communication circuit 220 may include an encoder and modulator 410, a digital beam-former 420, first to N-th transmission paths 430-1 to 430-N, and an analog beam-former 440, at least one of which may include a direct circuit structure, or may be a software module, firmware, or a combination of hardware and software implemented by the processor 210 or a separate microprocessor including a CPU.

The encoder and modulator 410 may perform channel encoding. For channel encoding, at least one of a low density parity check (LDPC) code, a convolution code, and a polar code may be used. The encoder and modulator 410 may generate modulation symbols by performing constellation mapping.

The digital beam-former 420 may perform beam-forming on a digital signal (e.g., modulation symbols). To this end, the digital beam-former 420 may multiply modulation symbols by beam-forming weights. The beam-forming weights are used to change the magnitude and the phase of signals, and may be referred to as a ‘precoding matrix’ or a ‘precoder’. The digital beam-former 420 may output digital beam-formed modulation symbols to the first to N-th transmission paths 430-1 to 430-N. In this case, according to a multiple input multiple output (MIMO) transmission technique, modulation symbols may be multiplexed or the same modulation symbols may be provided to the first to N-th transmission paths 430-1 to 430-N.

The first to N-th transmission paths 430-1 to 430-N may convert the digital beam-formed signals into analog signals. To this end, the first to N-th transmission paths 430-1 to 430-N may each include an inverse fast Fourier transform (IFFT) operation unit, a cyclic prefix (CP) inserting unit, a digital-to-analog converter (DAC), and an up-converter. The CP inserting unit is for an Orthogonal Frequency Division Multiplexing (OFDM) scheme and may be excluded when another physical layer scheme (e.g., filter bank multi-carrier (FBMC)) is applied. In other words, the first to N-th transmission paths 430-1 to 430-N may provide independent signal processing processes for a plurality of streams generated through the digital beam-former 420, respectively. However, some of the components of the first to N-th transmission paths 430-1 to 430-N may be used in common, according to embodiments.

The analog beam-former 440 may perform beam-forming on the analog signals. To this end, the analog beam-former 440 may multiply the analog signals by beam-forming weights, and the beam-forming weights may be used to change the magnitude and the phase of signals.

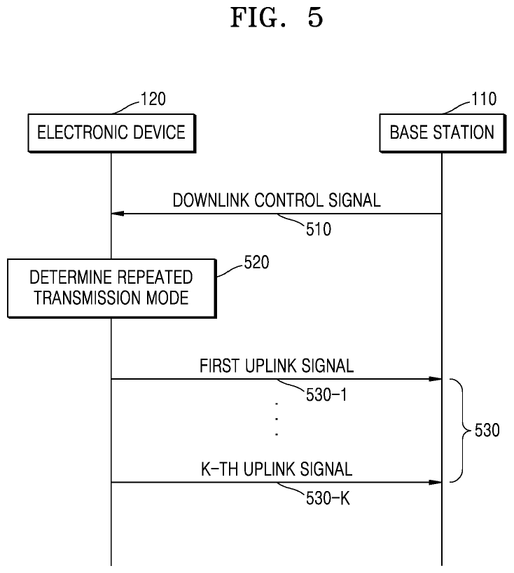

FIG. 5 is a diagram showing signal exchange between the base station 110 and the electronic device 120, according to embodiments.

Referring to FIG. 5, in operation 510, the base station 110 may transmit a downlink control signal to the electronic device 120. The downlink control signal may be generated in response to a failure of receiving an uplink signal transmitted from the electronic device 120. The downlink control signal may include, for example, a signal instructing a configuration or grant regarding the NR PUSCH repetition mode. The downlink control signal may include information regarding the number of repetitions for transmitting an uplink signal by the electronic device 120. For example, the number of repetitions is k, which may range from one (1) to eight (8). In other words, when k is 8, the electronic device 120 may receive the downlink control signal and repeatedly transmit an uplink signal to the base station 110 eight (8) times.

Although it has been described above that the downlink control signal requests to repeatedly transmit an NR PUSCH signal, the disclosure is not limited thereto. The base station 110 may request the electronic device 120 to repeatedly transmit not only the NR PUSCH signal including, for example, user data or payload but also an NR Physical Uplink Control CHannel (PUCCH) signal including, for example, control information.

In operation 520, the electronic device 120 may determine a repeated transmission mode. The repeated transmission controller 211 of the processor 210 may determine the repeated transmission mode. For example, the repeated transmission controller 211 may determine the repeated transmission mode by selecting a main mode from among a plurality of main modes and selecting a sub-mode among a plurality of sub-modes. The main mode may indicate any one of a precoding matrix, an analog transmission beam, and transmission power to be changed every time an uplink signal is transmitted. The sub-mode may indicate any one of a criterion for changing a precoding matrix, and a criterion for changing an analog transmission beam when the uplink signal is repeatedly transmitted. For example, a precoding matrix may be randomly selected or may be selected based on a result of channel estimation. An analog transmission beam may be randomly selected or may be selected based on a result of channel estimation. For transmission power, a transmission power value may be variably set based on at least one of a path loss value and a BLER value.

In operation 530, the electronic device 120 may transmit an uplink signal to the base station 110 repeatedly k times. For example, the electronic device 120 may successively transmit first to k-th uplink signals 530-1 to 530-k to the base station 110. At this time, the first to k-th uplink signals 530-1 to 530-k may include the same data. Also, the first to k-th uplink signals 530-1 to 530-k may be transmitted through different transmission techniques, respectively. For example, the first uplink signal 530-1 may be transmitted to the base station 110 through a first analog transmission beam from among a plurality of analog transmission beams, and the k-th uplink signal 530-k may be transmitted to the base station 110 through a second analog transmission beam from among the plurality of analog transmission beams. The first analog transmission beam may be different from the second analog transmission beam, for example, in magnitude and/or phase.

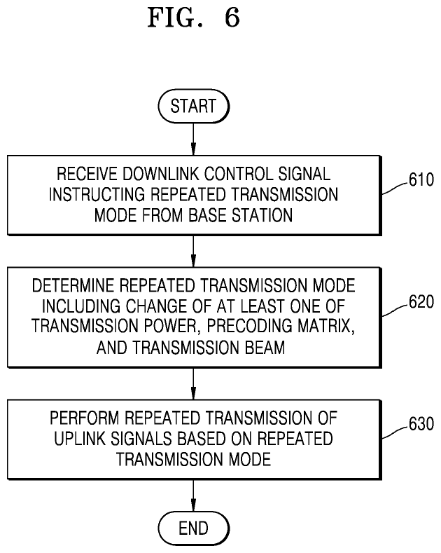

FIG. 6 is a flowchart of a method of operating the electronic device 120, according to embodiments.

Referring to FIG. 6, in operation 610, the electronic device 120 may receive a downlink control signal instructing a repetition mode from the base station 110. The downlink control signal may include information regarding the number of repetitions for transmission of an uplink signal. For example, the number of repetitions may have a value k, which may range from one (1) to eight (8).

In operation 520, the electronic device 120 may determine a repeated transmission mode indicating a change of at least one of transmission power, a precoding matrix, and an analog transmission beam when repeatedly transmitting an uplink signal to the base station 110. The electronic device 120 may determine at least one to be changed among the transmission power, the precoding matrix, and the analog transmission beam, and determine at least one of a criterion for changing the transmission power, a criterion for the precoding matrix, and a criterion for the analog transmission beam. For example, the electronic device 120 may determine to change a precoding matrix and an analog transmission beam from among transmission power, a precoding matrix, and an analog transmission beam when the uplink signal is repeatedly transmitted. The precoding matrix may be an arbitrary precoding matrix randomly selected from among precoding matrices in a codebook, or an optimal analog transmission beam selected based on a result of channel estimation.

According to an embodiment, the precoding matrix and the analog transmission beam may be changed according to the same criterion. For example, when there is a downlink signal newly received while the uplink signal is being repeatedly transmitted, the electronic device 120 may be able to estimate a downlink channel. Therefore, the electronic device 120 may obtain a result of channel estimation and select a precoding matrix and an analog transmission beam based thereon. As another example, when there is no downlink signal newly received while the uplink signal is being transmitted, no channel estimation will be performed during the repeated transmission of the uplink signal, and thus, the electronic device 120 may randomly select a precoding matrix and an analog transmission beam and transmit the uplink signal to the base station 110 based on the randomly selected precoding matrix and analog transmission beam. However, the disclosure is not limited thereto, and the electronic device 120 may randomly select a precoding matrix and an analog transmission beam even when there is a downlink signal newly received and a result of channel estimation may be obtained during the repeated transmission of the uplink signal. Also, the electronic device 120 may select an optimal precoding matrix according to a result of channel estimation and, at the same time, randomly select an analog transmission beam. Also, the electronic device 120 may select an optimal analog transmission beam according to a result of channel estimation and, at the same time, randomly select a precoding matrix.

In operation 630, the electronic device 120 may perform repeated transmission of the uplink signal based on the repeated transmission mode. For example, the electronic device 120 may successively transmit the uplink signal k times, that is, first to k-th uplink signals 530-1 to 530-K, to the base station 110. At this time, the first to k-th uplink signals 530-1 to 530-K may include the same data. Also, the first to k-th uplink signals 530-1 to 530-k may be transmitted through different transmission techniques, respectively.

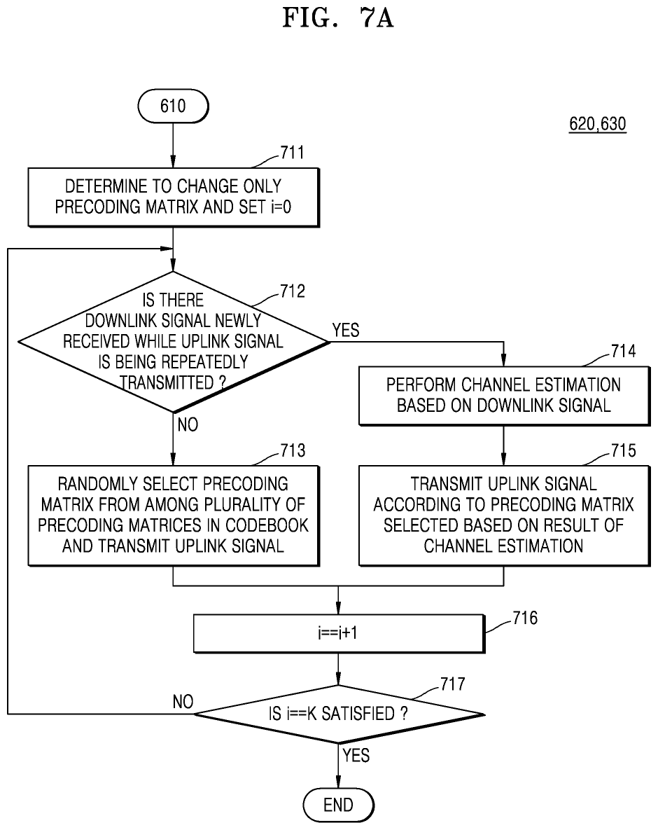

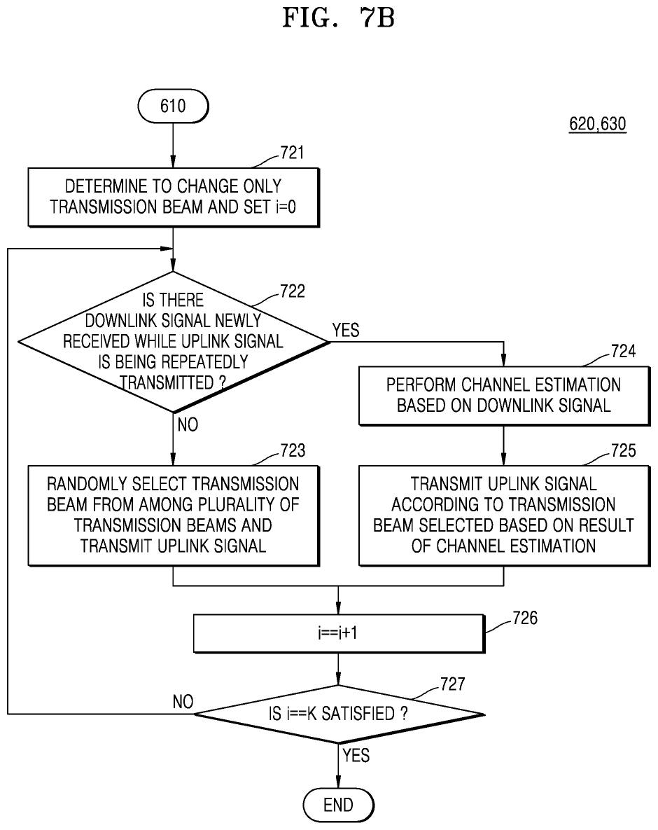

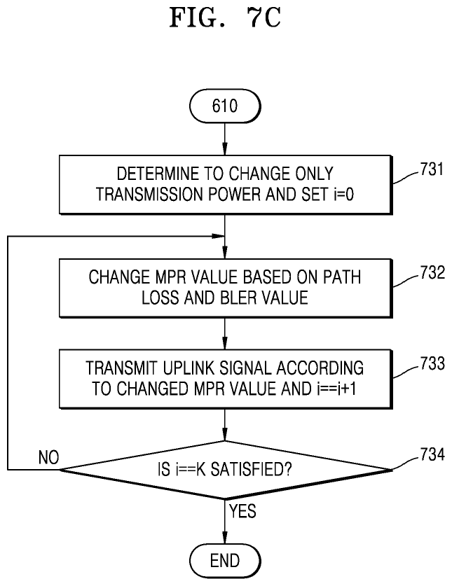

FIGS. 7A to 7C are flowcharts showing operation sequences of determining a repeated transmission mode, according to embodiments. FIGS. 7A to 7C relate to a first main mode for changing only one of a precoding matrix, an analog transmission beam, and a transmission power value. FIG. 7A illustrates an operation sequence of determining a precoding matrix, according to embodiments. The operation sequence of FIG. 7A corresponds to operations 620 and 630 of FIG. 6.

Referring to FIG. 7A, in operation 711 after operation 610 of FIG. 6, the electronic device 120 may determine to change only a precoding matrix, and set a value of a count i to 0. The electronic device 120 may determine the first main mode as the main mode of the repeated transmission mode for transmitting an uplink signal k times. The electronic device 120 may transmit an uplink signal by changing only one of a precoding matrix, an analog transmission beam, and transmission power without changing the other two of them. For example, the electronic device 120 may repeatedly transmit an uplink signal while changing only a precoding matrix. The count i is a counted value for determining whether transmission of the uplink signal k times is completed.

In operation 712, the electronic device 120 may determine whether there is a downlink signal newly received while the uplink signal is being repeatedly transmitted. However, at this time after operation 711 setting the value of the count to 0 and prior to a next operation which is operation 713 or 714, the electronic device 120 may determine whether there is a downlink signal received on or after operation 711 and prior to operation 713 or 714, according to an embodiment. The electronic device 120 may obtain k pieces of uplink scheduling information based on a downlink control signal received from the base station 110. The base station 110 may provide downlink scheduling information to the electronic device 120 to transmit a downlink signal to the electronic device 120. The electronic device 120 may determine whether there is an overlapping section between the downlink scheduling information and the uplink scheduling information. When there is an overlapping section, the electronic device 120 may receive a downlink signal from the base station 110 while an uplink signal is being repeatedly transmitted, and perform channel estimation based on the downlink signal.

In operation 713, when it is determined in operation 712 that there is no downlink signal, the electronic device 120 may transmit an uplink signal by randomly selecting a precoding matrix from among a plurality of precoding matrices in a codebook. For example, the repeated transmission controller 211 of FIG. 4 may provide a “logic high” control signal to the precoding matrix selector 212. The precoding matrix selector 212 may generate k random numbers by using a random number generator (not shown) in response to the “logic high” control signal, and the repeated transmission controller 211 may transmit an uplink signal by sequentially using precoding matrices in a codebook respectively corresponding to the k random numbers.

In operation 714, when it is determined in operation 712 that there is a downlink signal, the electronic device 120 may perform channel estimation based on the downlink signal. As described above, since there is a downlink signal newly received while the uplink signal is being repeatedly transmitted, the electronic device 120 may obtain downlink channel information by performing channel estimation based on the downlink signal. The electronic device 120 may estimate that a downlink channel and an uplink channel are the same based on channel reciprocity.

In operation 715, the electronic device 120 may transmit an uplink signal according to a precoding matrix selected based on a result of channel estimation performed in operation 714. The selected precoding matrix may be a precoding matrix determined to be optimal for an uplink channel based on a result of channel estimation. According to various embodiments, since a downlink signal is received while the uplink signal is being repeatedly transmitted, a transmission technique for transmitting the uplink signal may be changed based on a time point at which the downlink signal is received. For example, it is assumed that the downlink signal is received after a third uplink signal is transmitted. In this case, the electronic device 120 may transmit the first to third uplink signals by randomly selecting a precoding matrix. Thereafter, after the downlink signal is received and channel estimation is completed, fourth to k-th uplink signals may be transmitted according to an optimal precoding matrix selected based on a result of the channel estimation. Alternatively, the electronic device 120 may transmit the first to third uplink signals by using an optimal precoding matrix selected based on a result of previous channel estimation and, after the downlink signal is received and new channel estimation is completed, may transmit fourth to k-th uplink signals according to an optimal precoding matrix selected based on a result of the new channel estimation. When a precoding matrix is selected based on a result of channel estimation, the rank of an uplink signal to be transmitted may be maintained at a rank value at the time of initial transmission of the uplink signal. For example, a precoding matrix corresponding to the fourth uplink signal may be different from a precoding matrix corresponding to the first uplink signal, but the rank value of the fourth uplink signal may be equal to the rank value of the first uplink signal.

In operation 716, the electronic device 120 may increase the value of the count i by 1, and, in operation 717, the electronic device 120 may determine whether the value of the count i is equal to k. In other words, when the base station 110 has not transmitted the uplink signal the requested repetition number of times k, the process may return to operation 712 and repeat the operations performed above.

According to the embodiments described above, compared to the related art in which an uplink signal is repeatedly transmitted according to the same precoding matrix, transmission techniques may be diversified by changing a precoding matrix when an uplink signal is repeatedly transmitted.

FIG. 7B illustrates an operation sequence of determining an analog transmission beam, according to embodiments. The operation sequence of FIG. 7B corresponds to operations 620 and 630 of FIG. 6.

Referring to FIG. 7B, in operation 721 after operation 610 of FIG. 6, the electronic device 120 may determine to change only an analog transmission beam, and set a value of a count i to 0. In other words, while an uplink signals is being repeatedly transmitted, the electronic device 120 may change only the analog transmission beam without changing the precoding matrix and the transmission power.

In operation 722, the electronic device 120 may determine whether there is a downlink signal newly received while the uplink signal is being repeatedly transmitted. However, at this time after operation 721 setting the value of the count to 0 and prior to a next operation which is operation 723 or 724, the electronic device 120 may determine whether there is a downlink signal received on or after operation 711 and prior to operation 713 or 714, according to an embodiment. Since the description of operation 722 is substantially the same as that of operation 712, detailed description thereof will be omitted.

In operation 723, when it is determined in operation 722 that there is no downlink signal, the electronic device 120 may randomly select an analog transmission beam from among a plurality of analog transmission beams and transmit an uplink signal using the selected analog transmission beam. For example, the repeated transmission controller 211 of FIG. 4 may provide a “logic high” control signal to the analog transmission beam selector 213. The analog transmission beam selector 213 may generate k random numbers by using a random number generator (not shown) in response to the “logic high” control signal, and the repeated transmission controller may transmit an uplink signal k times by sequentially using analog transmission beams respectively corresponding to the k random numbers from among a plurality of available analog transmission beams. Thus, when the uplink signal is repeatedly transmitted, the analog transmission beam may change.

In operation 724, when it is determined in operation 722 that there is a downlink signal, the electronic device 120 may perform channel estimation based on the downlink signal. Since the description of operation 724 is substantially the same as that of operation 714, detailed description thereof will be omitted.

In operation 725, the electronic device 120 may transmit an uplink signal according to an analog transmission beam selected based on a result of channel estimation performed in operation 724. The selected analog transmission beam may be an analog transmission beam determined to be optimal for an uplink channel based on a result of channel estimation. According to various embodiments, since a downlink signal is received while the uplink signal is being repeatedly transmitted, a transmission technique for transmitting the uplink signal may be changed based on a time point at which the downlink signal is received. For example, it is assumed that the downlink signal is received after a third uplink signal is transmitted. In this case, the electronic device 120 may transmit the first to third uplink signals by randomly selecting an analog transmission beam. Thereafter, after the downlink signal is received and channel estimation is completed, fourth to k-th uplink signals may be transmitted according to an optimal analog transmission beam selected based on a result of the channel estimation. Alternatively, the electronic device 120 may transmit the first to third uplink signals by using an optimal analog transmission beam selected based on a result of previous channel estimation and, after the downlink signal is received and new channel estimation is completed, may transmit fourth to k-th uplink signals according to an optimal analog transmission beam selected based on a result of the new channel estimation. When an analog transmission beam is selected based on a result of channel estimation, the rank of an uplink signal to be transmitted may be maintained at a rank value at the time of initial transmission of the uplink signal. For example, an analog transmission beam corresponding to the fourth uplink signal may be different from an analog transmission beam corresponding to the first uplink signal, but the rank value of the fourth uplink signal may be equal to the rank value of the first uplink signal.

Since the descriptions of operations 726 and 727 are substantially the same as those of operations 716 and 717, detailed descriptions thereof will be omitted.

According to the embodiments described above, compared to the related art in which an uplink signal is repeatedly transmitted according to the same analog transmission beam, transmission techniques may be diversified by changing an analog transmission beam when an uplink signal is repeatedly transmitted.

FIG. 7C illustrates an operation sequence of determining a transmission power value, according to embodiments. The operation sequence of FIG. 7C corresponds to operations 620 and 630 of FIG. 6.

Referring to FIG. 7C, in operation 731 after operation 610 of FIG. 6, the electronic device 120 may determine to change only a transmission power value, and set the value of a count i to 0. In other words, while an uplink signal is being repeatedly transmitted, the electronic device 120 may change only the transmission power value while maintaining the precoding matrix and the analog transmission beam which are previously selected.

In operation 732, the electronic device 120 may change an MPR value based on a path loss value and a BLER value. The electronic device 120 may continuously monitor the path loss value and the BLER value based on a channel state. The electronic device 120 may change the MPR value to be inversely proportional to the path loss value and the BLER value. For example, when the channel state is deteriorated, the path loss value and the BLER value may be increased. In response to detection of increases of the path loss value and the BLER value, the electronic device 120 may decrease the MPR value to overcome the deteriorated channel state. In another example, when the channel condition is improved, the path loss value and the BLER value may be decreased. In response to deterioration of decreases of the path loss value and the BLER value, the electronic device 120 may be controlled to transmit an uplink signal with relatively low transmission power by increasing the MPR value by reflecting the improved channel state.

In operation 733, the electronic device 120 may transmit an uplink signal according to a changed MPR value, and may increase the value of the count i by 1. In other words, the electronic device 120 may change the MPR value when an uplink signal is transmitted until the uplink signal is repeatedly transmitted k times. For example, the channel state may be deteriorated while first to third uplink signals are being transmitted. The electronic device 120 may transmit fourth to k-th uplink signals based on a maximum transmission power value. As another example, the channel state may be improved while first to third uplink signals are being transmitted. The electronic device 120 may transmit the fourth to k-th uplink signals based on a value obtained by subtracting the MPR value from the maximum transmission power value. Since the descriptions of operation 734 are substantially the same as those of operations 717 and 727, detailed descriptions thereof will be omitted.

According to the embodiments described above, compared to the related art in which an uplink signal is repeatedly transmitted according to the same transmission power value, a probability of transmission failure of an uplink signal may be reduced by changing the MPR value based on the path loss value and the BLER value and transmitting the uplink signal according to a transmission power values changed according to the changed MPR value.

FIGS. 8A to 8C are flowcharts showing other operation sequences of determining a repeated transmission mode, according to embodiments. FIGS. 8A to 8C relate to a second main mode for changing two of a precoding matrix, an analog transmission beam, and a transmission power value. FIG. 8A illustrates an operation sequence of determining a precoding matrix and an analog transmission beam, according to embodiments. The operation sequence of FIG. 8A corresponds to operations 620 and 630 of FIG. 6.

Referring to FIG. 8A, in operation 811 after operation 610 of FIG. 6, the electronic device 120 may determine to change a precoding matrix and an analog transmission beam and set the value of a count i to 0. The electronic device 120 may determine the second main mode as the main mode of the repeated transmission mode for transmitting an uplink signal k times. The electronic device 120 may transmit an uplink signal by changing only two of a precoding matrix, an analog transmission beam, and transmission power without changing the other one of them. For example, the electronic device 120 may repeatedly transmit an uplink signal by changing a precoding matrix and an analog transmission beam while a transmission power value is not changed.

In operation 812, the electronic device 120 may determine whether there is a downlink signal newly received while the uplink signal is being repeatedly transmitted. Since the description of operation 812 is substantially the same as that of operation 712, detailed description thereof will be omitted.

In operation 813, when it is determined in operation 812 that there is no downlink signal, the electronic device 120 may randomly select a precoding matrix and an analog transmission beam, and transmit an uplink signal using the randomly-selected precoding matrix and the analog transmission beam. The repeated transmission controller 211 may provide a “logic high” control signal to each of the precoding matrix selector 212 and the analog transmission beam selector 213. The precoding matrix selector 212 may generate k random numbers by using a random number generator (not shown) in response to the “logic high” control signal, and select k precoding matrices corresponding to the k random numbers from among a plurality of precoding matrices in a codebook. The analog transmission beam selector 213 may generate k random numbers by using a random number generator (not shown) in response to the “logic high” control signal and select k analog transmission beams corresponding to the k random numbers from among a plurality of analog transmission beams. The electronic device 120 may transmit an uplink signal by changing a precoding matrix and an analog transmission beam when the uplink signal is transmitted by sequentially using the precoding matrices and the analog transmission beams corresponding to the k random numbers. Meanwhile, the repeated transmission controller 211 may not provide a control signal to the transmission power controller 214, because the transmission power needs to be maintained the same.

In operation 814, when it is determined in operation 812 that there is a downlink signal, the electronic device 120 may perform channel estimation based on the downlink signal. Since the description of operation 814 is substantially the same as that of operation 714, detailed description thereof will be omitted.

In operation 815, the electronic device 120 may transmit an uplink signal according to an analog transmission beam and a precoding matrix selected based on a result of channel estimation performed in operation 814. The selected analog transmission beam may be an analog transmission beam determined to be optimal for transmitting an uplink signal based on a result of channel estimation. The selected precoding matrix may be a precoding matrix determined to be optimal for transmitting an uplink signal based on a result of channel estimation. According to various embodiments, since a downlink signal is received while the uplink signal is being repeatedly transmitted, a transmission technique for transmitting the uplink signal may be changed based on a time point at which the downlink signal is received. For example, it is assumed that the downlink signal is received after a third uplink signal is transmitted. In this case, the electronic device 120 may transmit the first to third uplink signals by randomly selecting an analog transmission beam and randomly selecting a precoding matrix. Thereafter, after the downlink signal is received and channel estimation is completed, fourth to k-th uplink signals may be transmitted according to an optimal analog transmission beam and an optimal precoding matrix selected based on a result of the channel estimation. Alternatively, the electronic device 120 may transmit the first to third uplink signals by using an optimal analog transmission beam and an optimal precoding matrix selected based on a result of previous channel estimation and, after the downlink signal is received and new channel estimation is completed, may transmit fourth to k-th uplink signals according to an optimal analog transmission beam and an optimal precoding matrix selected based on a result of the new channel estimation.

Since the descriptions of operations 816 and 817 are substantially the same as those of operations 716 and 717, detailed descriptions thereof will be omitted.

According to the embodiments described above, compared to the related art in which an uplink signal is repeatedly transmitted according to the same analog transmission beam and the same precoding matrix, transmission techniques may be diversified by changing an analog transmission beam and a precoding matrix when an uplink signal is repeatedly transmitted.

FIG. 8B illustrates an operation sequence of determining a precoding matrix and transmission power, according to embodiments. The operation sequence of FIG. 8B corresponds to operations 620 and 630 of FIG. 6.

Referring to FIG. 8B, in operation 821 after operation 610 of FIG. 6, the electronic device 120 may determine to change a precoding matrix and transmission power and set the value of a count i to 0. In other words, the electronic device 120 may determine the second main mode as the main mode of the repeated transmission mode for transmitting an uplink signal k times. The electronic device 120 may repeatedly transmit an uplink signal by changing a precoding matrix and transmission power without changing an analog transmission beam.

In operation 822, the electronic device 120 may determine whether there is a downlink signal newly received while the uplink signal is being repeatedly transmitted. Since the description of operation 822 is substantially the same as that of operation 712, detailed description thereof will be omitted.

In operation 823, when it is determined in operation 822 that there is no downlink signal, the electronic device 120 may randomly select a precoding matrix from among a plurality of precoding matrices in a codebook and may transmit an uplink signal by changing an MPR value according to a path loss and a BLER value. The repeated transmission controller 211 may provide a “logic high” control signal to the precoding matrix selector 212. The precoding matrix selector 212 may generate k random numbers by using a random number generator (not shown) in response to the “logic high” control signal and select k precoding matrices corresponding to the k random numbers from among a plurality of precoding matrices in a codebook. The repeated transmission controller 211 may monitor the path loss value and the BLER value in real time. For example, when the path loss value and the BLER value increase, the repeated transmission controller 211 may provide a “logic low” control signal to the transmission power controller 214. The transmission power controller 214 may decrease the MPR value in response to the “logic low” control signal. In other words, the electronic device 120 may transmit an uplink signal with transmission power obtained by subtracting the MPR value from the maximum transmission power value. However, since the MPR value has decreased, the electronic device 120 may transmit the uplink signal with a higher transmission power. In another example, when the path loss value and the BLER value decrease, the repeated transmission controller 211 may provide a “logic high” control signal to the transmission power controller 214. The transmission power controller 214 may increase the MPR value in response to the “logic high” control signal. Since the MPR value has decreased, the electronic device 120 may transmit an uplink signal with a lower transmission power. That is, the electronic device 120 may change transmission power by reflecting the path loss value and the BLER value monitored in real time when an uplink signal is repeatedly transmitted. Meanwhile, since the uplink signal is transmitted by using the same analog transmission beam, the repeated transmission controller 211 may not provide a control signal to the analog transmission beam selector 213 in this example.

In operation 824, when it is determined in operation 822 that there is a downlink signal, the electronic device 120 may perform channel estimation based on a downlink signal. Since the description of operation 824 is substantially the same as that of operation 714, detailed description thereof will be omitted.

In operation 825, the electronic device 120 may select a precoding matrix based on a result of channel estimation, and may transmit an uplink signal by changing the MPR value according to the path loss value and the BLER value. The selected precoding matrix may be a precoding matrix determined to be optimal for transmitting an uplink signal based on a result of channel estimation. When an uplink signal is repeatedly transmitted, the electronic device 120 may transmit a corresponding uplink signal with transmission power changed by changing the MPR value based on the path loss value and the BLER value monitored in real time.

Since the descriptions of operations 826 and 827 are substantially the same as those of operations 716 and 717, detailed descriptions thereof will be omitted.

According to the embodiments described above, compared to the related art in which an uplink signal is repeatedly transmitted according to the same precoding matrix and the same transmission power value, transmission techniques may be diversified by changing a transmission power value and a precoding matrix when an uplink signal is repeatedly transmitted.

FIG. 8C illustrates an operation sequence of determining an analog transmission beam and transmission power, according to embodiments.

Referring to FIG. 8C, in operation 831, the electronic device 120 may determine to change an analog transmission beam and transmission power, and set the value of a count i to 0. The electronic device 120 may change an analog transmission beam and transmission power when an uplink signal is repeatedly transmitted and maintain a precoding matrix the same.

In operation 832, the electronic device 120 may determine whether there is a downlink signal newly received while the uplink signal is being repeatedly transmitted. Since the description of operation 832 is substantially the same as that of operation 712, detailed description thereof will be omitted.

In operation 833, when it is determined in operation 832 that there is no downlink signal, the electronic device 120 may randomly select an analog transmission beam from among a plurality of analog transmission beams, and may transmit an uplink signal by changing an MPR value according to a path loss and a BLER value. The repeated transmission controller 211 may provide a “logic high” control signal instructing the random selection to the analog transmission beam selector 213. The analog transmission beam selector 213 may generate k random numbers by using a random number generator (not shown) in response to the “logic high” control signal, and select k analog transmission beams corresponding to the k random numbers from among a plurality of analog transmission beams. For example, a first uplink signal may be transmitted to the base station 110 through a first transmission beam, and a second uplink signal may be transmitted to the base station 110 through a second transmission beam. In this case, the first transmission beam and the second transmission beam may be different from each other. The repeated transmission controller 211 may provide a control signal for increasing or decreasing the MPR value to the transmission power controller 214 by monitoring the path loss value and the BLER value in real time. For example, when the path loss value and the BLER value increase, the repeated transmission controller 211 may provide a “logic low” control signal to the transmission power controller 214. The transmission power controller 214 may decrease the MPR value in response to the “logic low” control signal, and thus the electronic device 120 may transmit an uplink signal with a higher transmission power. In another example, when the path loss value and the BLER value decrease, the repeated transmission controller 211 may provide a “logic high” control signal to the transmission power controller 214. The transmission power controller 214 may increase the MPR value in response to the “logic high” control signal, and thus the electronic device 120 may transmit an uplink signal with a lower transmission power. Meanwhile, since the uplink signal is transmitted by using the same precoding matrix, the repeated transmission controller 211 may not provide a control signal to precoding matrix selector 212 in this example.

In operation 834, the electronic device 120 may perform channel estimation based on a downlink signal. Since the description of operation 834 is substantially the same as that of operation 714, detailed description thereof will be omitted.

In operation 835, the electronic device 120 may select an analog transmission beam from among a plurality of analog transmission beams based on a result of channel estimation, and may transmit an uplink signal by changing the MPR value according to the path loss value and the BLER value. The selected analog transmission beam may be an analog transmission beam determined to be optimal for transmitting an uplink signal based on a result of channel estimation. When an uplink signal is repeatedly transmitted, the electronic device 120 may transmit a corresponding uplink signal by using transmission power changed by changing the MPR value based on the path loss value and the BLER value monitored in real time and the selected analog transmission beam. Since the descriptions of operations 836 and 837 are substantially the same as those of operations 716 and 717, detailed descriptions thereof will be omitted.

According to the embodiments described above, compared to the related art in which an uplink signal is repeatedly transmitted according to the same analog transmission beam and the same transmission power, transmission techniques may be diversified by changing transmission power and an analog transmission beam when an uplink signals is repeatedly transmitted.

FIG. 9 is a flowchart an operation sequence of determining a repeated transmission mode, according to embodiments. FIG. 9 relates to a third main mode for changing all of a precoding matrix, an analog transmission beam, and transmission power.

Referring to FIG. 9, in operation 911, the electronic device 120 may determine to change a precoding matrix, an analog transmission beam, and transmission power, and set the value of a count i to 0. The electronic device 120 may determine the third main mode as the main mode of the repeated transmission mode for transmitting an uplink signal k times. The electronic device 120 may change a precoding matrix, an analog transmission beam, and transmission power when an uplink signal is repeatedly transmitted.

In operation 912, the electronic device 120 may determine whether there is a downlink signal newly received while the uplink signal is being repeatedly transmitted. Since the description of operation 912 is substantially the same as that of operation 712, detailed description thereof will be omitted.

In operation 913, when it is determined in operation 912 that there is no downlink signal, the electronic device 120 may randomly select a precoding matrix and an analog transmission beam, and may transmit an uplink signal by changing an MPR value according to a path loss and a BLER value. To this end, the repeated transmission controller 211 may provide a “logic high” control signal to each of the precoding matrix selector 212 and the analog transmission beam selector 213. The precoding matrix selector 212 may generate k random numbers by using a random number generator (not shown) in response to the “logic high” control signal, and select k precoding matrices corresponding to the k random numbers from among a plurality of precoding matrices in a codebook. The analog transmission beam selector 213 may generate k random numbers by using a random number generator (not shown) in response to the “logic high” control signal, and select k analog transmission beams corresponding to the k random numbers from among a plurality of analog transmission beams. The repeated transmission controller 211 may monitor the path loss value and the BLER value and provide a control signal for changing the MPR value to be inversely proportional to the path loss value and the BLER value to the transmission power controller 214. For example, when the path loss value and the BLER value increase, a “logic low” control signal for decreasing the MPR value may be provided to the transmission power controller 214. In another example, when the path loss value and the BLER value decrease, a “logic high” control signal for increasing the MPR value may be provided to the transmission power controller 214. The electronic device 120 may transmit k uplink signals by sequentially using the precoding matrices and the analog transmission beams corresponding to the k random numbers and transmission power determined according to the changed MPR value.

In operation 914, when it is determined in operation 912 that there is a downlink signal, the electronic device 120 may perform channel estimation based on a downlink signal. Since the description of operation 914 is substantially the same as that of operation 714, detailed description thereof will be omitted.

In operation 915, the electronic device 120 may transmit an uplink signal according to an analog transmission beam and a precoding matrix selected based on a result of channel estimation, and transmit the uplink signal by changing the MPR value according to the path loss value and the BLER value. The selected analog transmission beam may be an analog transmission beam determined to be optimal for transmitting an uplink signal based on a result of channel estimation. The selected precoding matrix may be a precoding matrix determined to be optimal for transmitting an uplink signal based on a result of channel estimation.

Since the descriptions of operations 916 and 917 are substantially the same as those of operations 716 and 717, detailed descriptions thereof will be omitted.

According to the embodiments described above, compared to the related art in which an uplink signal is repeatedly transmitted according to the same precoding matrix, the same analog transmission beam and the same transmission power, transmission techniques may be diversified by changing an analog transmission beam and a precoding matrix when an uplink signal is transmitted using transmission power determined based on a path loss value and a BLER value.

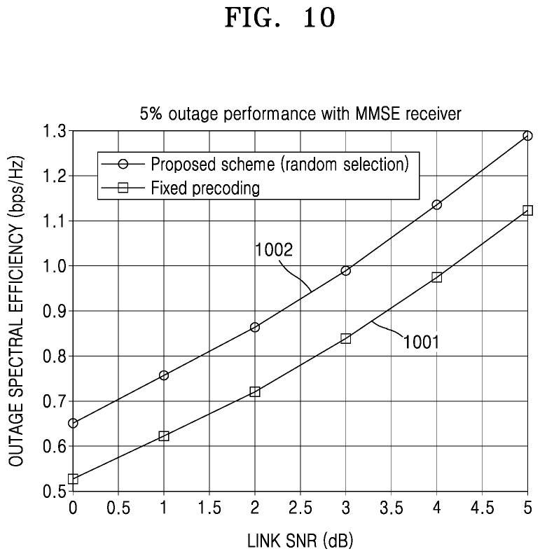

FIG. 10 shows a result graph according to embodiments.

Referring to FIG. 10, the electronic device 120 may be based on the first main mode. According to the first main mode, when an uplink signal is repeatedly transmitted, the electronic device 120 may change one of a precoding matrix, an analog transmission beam, and transmission power. For example, the electronic device 120 may change a precoding matrix when an uplink signal is repeatedly transmitted. The electronic device 120 may be based on the first sub-mode. The first sub-mode may be a mode for randomly selecting a precoding matrix.

Referring to FIG. 10, the X-axis of the graph represents link signal-to-noise ratio (SNR) values indicating channel states, and the Y-axis represents spectral efficiency. A first result 1001 indicates spectral efficiency when an uplink signal is repeatedly transmitted by using the same transmission technique. A second result 1002 indicates spectral efficiency when only a precoding matrix is changed when an uplink signal is repeatedly transmitted. In detail, the second result 1002 may be based on the first main mode (a mode for changing only one of a precoding matrix, an analog transmission beam, and transmission power) and a second sub-mode (a sub-mode for random selection in the first main mode for changing only a precoding matrix) for randomly selecting one precoding matrix from among a plurality of precoding matrices stored in a code book when an uplink signal is repeatedly transmitted). As shown in the graph, it may be confirmed that the spectral efficiency of the second result 1002 is improved compared to that of the first result 1001 by randomly changing a precoding matrix when an uplink signal is repeatedly transmitted.

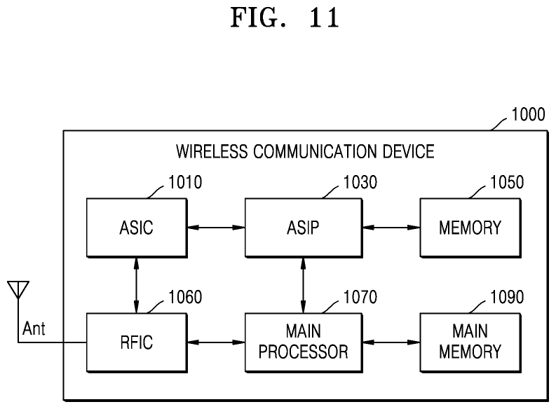

FIG. 11 is a block diagram of a wireless communication device according to an embodiment.

Referring to FIG. 11, a wireless communication device 1000 may include a modem (not shown) and a radio frequency integrated circuit (RFIC) 1060, and the modem may include an application specific integrated circuit (ASIC) 1010, an application specific instruction set processor (ASIP) 1030, a memory 1050, a main processor 1070, and a main memory 1090. The wireless communication device 1000 of FIG. 11 may correspond to the electronic device 120 according to an embodiment.

The RFIC 1060 may be connected to an antenna Ant to receive a signal from the outside or transmit a signal to the outside by using a wireless communication network. The ASIP 1030 is an integrated circuit customized for a particular purpose, may support a dedicated instruction set for a particular application, and execute instructions included in the instruction set. The memory 1050 may communicate with the ASIP 1030, and may be a non-volatile storage device that stores a plurality of instructions to be executed by the ASIP 1030. For example, the memory 1050 may include any type of memory accessible by the ASIP 230, which may be, but is not limited to, a random access memory (RAM), a read only memory (ROM), a tape, a magnetic disk, an optical disk, a volatile memory, a non-volatile memory, and a combination thereof.

The main processor 1070 may control the wireless communication device 1000 by executing a plurality of instructions. For example, the main processor 1070 may control the ASIC 1010 and the ASIP 1030, process data received via a wireless communication network, or process a user input regarding the wireless communication device 1000. For example, the main processor 1070 may determine a repeated transmission mode for repeatedly transmitting an uplink signal. The main processor 1070 may determine a main mode for transmitting an uplink signal by changing at least one of a precoding matrix, an analog transmission beam, and transmission power and a sub-mode for selecting a precoding matrix and an analog transmission beam randomly or based on a result of channel estimation when changing the precoding matrix and the analog transmission beam. Therefore, transmission techniques may be diversified by repeatedly transmitting an uplink signal using different transmission techniques, thereby lowering a packet error rate for improved reliability.

The main memory 1090 may communicate with the main processor 1070, and may be a non-volatile storage device that stores a plurality of instructions to be executed by the main processor 1070. For example, the main memory 1090 may include any type of memory accessible by the main processor 1070, which may be, but is not limited to, a random access memory (RAM), a read only memory (ROM), a tape, a magnetic disk, an optical disk, a volatile memory, a non-volatile memory, and a combination thereof.

While the disclosure has been particularly shown and described with reference to embodiments thereof, it will be understood that various changes in form and details may be made therein without departing from the spirit and scope of the following claims.

What is claimed is:

1. A method of operating an electronic device, the method comprising:
receiving, from a base station, a downlink control signal requesting repeated transmission of an uplink signal;
determining a repeated transmission mode for changing at least one of a precoding matrix, an analog transmission beam, and transmission power of the uplink signal when the uplink signal is repeatedly transmitted in response to reception of the downlink control signal; and
repeatedly transmitting the uplink signal according to a determined repeated transmission mode.

2. The method of claim 1, wherein the repeated transmission mode comprises a main mode and a sub-mode, and
wherein the main mode comprises any one of:
a first main mode indicating to change one of the precoding matrix, the analog transmission beam, and the transmission power;
a second main mode indicating to change two of the precoding matrix, the analog transmission beam, and the transmission power; and
a third main mode indicating to change all of the precoding matrix, the analog transmission beam, and the transmission power.

3. The method of claim 2, wherein the sub-mode comprises:
a first sub-mode for randomly selecting one of a plurality of precoding matrices as the changed precoding matrix;
a second sub-mode for selecting one of the plurality of precoding matrices as the changed precoding matrix based on a result of channel estimation;
a third sub-mode for randomly selecting one of a plurality of analog transmission beams as the changed analog transmission beam; and
a fourth sub-mode for selecting one of the plurality of analog transmission beams as the changed analog transmission beam based on the result of the channel estimation.

4. The method of claim 1, wherein the downlink control signal further comprises information indicating a number of times for repeatedly transmitting the uplink signal.

5. The method of claim 1, wherein the determining the repeated transmission mode comprises:
determining whether there is a downlink signal received while the uplink signal is being repeatedly transmitted;
performing channel estimation based on the downlink signal when there is the downlink signal; and
changing at least one of the precoding matrix and the analog transmission beam based on a result of the channel estimation.

6. The method of claim 1, further comprising:
monitoring a path loss and a block error rate; and
changing a maximum power reduction (MPR) value based on a result of the monitoring based on the determined repeated transmission mode comprising a mode for changing the transmission power.

7. The method of claim 6, wherein the changing the MPR value comprises:
in response to detection of increases in the path loss and the block error rate, decreasing the MPR value; and,
in response to detection of decreases in the path loss and the block error rate, increasing the MPR value.

8. An electronic device comprising:
a communication circuit configured to receive, from a base station, a downlink control signal requesting repeated transmission of an uplink signal; and
a processor configured to:
determine a repeated transmission mode for changing one of a precoding matrix, an analog transmission beam, and transmission power of the uplink signal; and
repeatedly transmit the uplink signal according to the determined repeated transmission mode.

9. The electronic device of claim 8, wherein the processor is configured to:
determine to change the precoding matrix when the uplink signal is repeatedly transmitted; and
transmit the uplink signal repeatedly according to the changed precoding matrix which is randomly selected or selected based on a result of channel estimation, from among a plurality of precoding matrices.

10. The electronic device of claim 9, wherein the processor is configured to:
determine whether there is a downlink signal received while the uplink signal is being repeatedly transmitted;
perform channel estimation based on the downlink signal based on determining that there is the downlink signal;
select the changed precoding matrix based on the result of the channel estimation; and,
randomly select the changed precoding matrix from among the plurality of precoding matrices based on determining that there is no downlink signal.

11. The electronic device of claim 8, wherein the processor is configured to:
determine to change the analog transmission beam when the uplink signal is repeatedly transmitted; and
transmit the uplink signal repeatedly according to the changed analog transmission beam which is randomly selected or selected based on a result of channel estimation, from among a plurality of analog transmission beams.

12. The electronic device of claim 11, wherein the processor is configured to:
determine whether there is a downlink signal received while the uplink signal is being repeatedly transmitted;
perform channel estimation based on the downlink signal based on determining that there is the downlink signal;
select the changed analog transmission beam based on the result of the channel estimation; and
randomly select the changed analog transmission beam based on determining that there is no downlink signal.

13. The electronic device of claim 8, wherein the processor is configured to:
determine to change the transmission power when the uplink signal is repeatedly transmitted;
monitor a path loss and a block error rate in real time;
change a maximum power reduction (MPR) value based on a result of the monitoring; and
transmit the uplink signal using the changed transmission power obtained by subtracting the MPR value from a predetermined transmission power value.

14. The electronic device of claim 13, wherein the processor is configured to:
decrease the MPR value in response to detecting an increase in the path loss and the block error rate; and
increases the MPR value in response to detection of decreases in the path loss and the block error rate.

15. The electronic device of claim 8, wherein the downlink control signal further comprises information indicating a number of times for repeatedly transmitting the uplink signal.

16. An electronic device comprising:
a communication circuit configured to receive, from a base station, a downlink signal requesting repeated transmission of an uplink signal; and
a processor configured to change at least one of a precoding matrix, an analog transmission beam, and transmission power of the uplink signal when the uplink signal is repeatedly transmitted to the base station.

17. The electronic device of claim 16, wherein the processor is configured to change the precoding matrix and the analog transmission beam when the uplink signals is repeatedly transmitted,
wherein the changed precoding matrix is randomly selected from among a plurality of precoding matrices, or selected based on a result of channel estimation, and
wherein the changed analog transmission beam is randomly selected or selected based on the result of the channel estimation, from among a plurality of analog transmission beams.

18. The electronic device of claim 17, wherein the processor is configured to:
determine whether there is a downlink signal received while the uplink signal is being repeatedly transmitted; and
perform the channel estimation based on the downlink signal.

19. The electronic device of claim 16, wherein the processor is configured to change the precoding matrix and the transmission power when the uplink signal is repeatedly transmitted,
wherein the changed precoding matrix is randomly selected from among a plurality of precoding matrices, or selected based on a result of channel estimation, and
wherein the changed transmission power is determined based on a path loss and a block error rate.

20. The electronic device of claim 19, wherein the processor is configured to:
monitors the path loss and the block error rate in real time;
changes a maximum power reduction (MPR) value based on a result of the monitoring; and
determine the changed transmission power by subtracting the MPR value from a predetermined transmission power value.
